(19) United States
(12) Patent Application Publication
(10) Pub. No.: US 2019/0113787 A1
(43) Pub. Date: Apr. 18, 2019

(54) FABRICATING METHOD OF PHOTO SPACER IN LIQUID CRYSTAL DISPLAY PANEL AND LIQUID CRYSTAL DISPLAY PANEL

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventors: Wu CAO, Shenzhen, Guangdong (CN); Minggang LIU, Shenzhen, Guangdong (CN)

(21) Appl. No.: 15/742,101

(22) PCT Filed: Nov. 7, 2017
(86) PCT No.: PCT/CN2017/109706

§ 371 Date: Jan. 5, 2018

(30) Foreign Application Priority Data
Oct. 13, 2017 (CN) 201710952802.6

(51) Int. Cl. G02F 1/1339; G02F 1/1362

(52) U.S. Cl. CPC G02F 1/1339; G02F 1/13394; G02F 1/136286; G02F 1/136209; G02F 1/133528; G02F 2001/13398; G02F 2001/136222; G02F 2001/136236; G02F 2001/13396

(57) ABSTRACT

A fabricating method of photo spacers in liquid crystal display (LCD) panel and a LCD panel are provided, including the following steps: forming a first pad and a second pad on an array substrate; forming a black spacer layer on the array substrate, and covering the first and the second pads by the black spacer layer; and patterning the black spacer layer to obtain a main photo spacer, an sub photo spacer, and a black matrix having a height difference, the main photo spacer being located above the first pad, and the sub photo spacer being located above the second pad, and the main photo spacer being higher than the sub photo spacer. The disclosure can reduce the material sensitivity requirement for fabricating the black spacer layer, reduce the alignment difficulty of the multilayer color resist pad, thereby reducing the fabrication cost of the photo spacers and the LCD panel.

### RELATED APPLICATIONS

The present application is a National Phase of International Application Number PCT/CN2017/109706, filed Nov. 7, 2017, and claims the priority of China Application No. 201710952802.6, filed Oct. 13, 2017.

### FIELD OF THE DISCLOSURE

The disclosure relates to the field of display technology, and in particular, to a fabricating method of a spacer in a liquid crystal display panel and a liquid crystal display panel.

### BACKGROUND

BPS (Black Photo Spacer)/BCS (Black Colum Spacer) technology refers to a technology in a conventional LCD (Liquid Crystal Display) fabricating, which the two processes of black matrix (BM) and photo spacer (PS) are combined in one process, that is, a black spacer layer is formed by using the same black shading material (i.e. BPS material). The black spacer layer includes a black matrix and photo spacers structure, in which photo spacers that serve as a support function generally have two different height values; the higher one is a main photo spacer (Main PS), which is mainly used to define the cell thickness; the shorter one is a sub photo spacer (Sub PS), which is used to improve the supporting ability of the liquid crystal display panel when pressed by an external force, and the black matrix at the lowest position plays a major role in light shielding.

According to the differences of the photosensitive properties and the specific structure of the BPS materials, the technology generally can be classified into 3 Tone, 2 Tone, and 1 Tone, based on the number of the transmittance region of the exposure mask.

In addition to the light-shielding zone (transmittance is 0), there are N other transmittance regions in a general mask, the technology is known as N Tone; A conventional full tone mask (FTM) refers to a normal photomask with a transmittance of only 100%. 3 Tone is a mask including three different transmittance regions, for example, the transmittances of three different transmittance regions respectively are 100%, 30%, and 20%; 2 Tone is a mask including two different transmittance regions, for example, the transmittances of two different transmittance regions respectively are 100% and 20%.

More detailed, 3 Tone technology refers to the use of a special mask including three different transmittance (having transmittance of 100%) regions to expose and develop the BPS material layer on the lower substrate, so as to form three height difference on the BPS material layer; 2 Tone technology refers to a pad (generally a filter layer) disposed below the main photo spacer; by using the pad to hold the main photo spacer, the BPS material layer on the lower substrate is exposed and developed by using the mask having two different transmittance regions to form three height difference. The ultimate height of the main photo spacer is a thickness of the monolayer pad plus a thickness of the BPS material layer, and the height of the sub photo spacer and black matrix are both the thickness of the BPS material layer. 1 Tone technology refers to two layers of pads are disposed below the main photo spacers (two layers of color filter layers are generally used), and a layer of pad is disposed below the sub photo spacers, which forms the original height difference with the two layers of pad disposed below the main photo spacers, and finally, the BPS material layer on the lower substrate is exposed and developed by using a fully transparent mask having a transmittance of only 100% to obtain three height differences. Here, the height of the main photo spacer is the thickness of the two layers of pad plus the thickness of the BPS material layer; the height of the sub photo spacer is the thickness of the single-layer spacer plus the thickness of the BPS material layer; and the height of the black matrix is the thickness of the BPS material layer.

When using the above technical proposal to fabricate the spacer, it has the following disadvantages that in 1 Tone technology, since a double layer of color resist is stacked below the main photo spacer and only one layer of color resist is stacked below the sub photo spacer, when stacking a double layer of color resist, the difficulty of aligning the double layer of color resist is increased. In 2 Tone and 3 Tone technologies, the amount of light corresponding to different regions of the BPS material layer is different, using high sensitivity BPS material is needed, and the use of high sensitivity BPS material will increase the fabrication cost of the photo spacer and the liquid crystal display panel.

### SUMMARY

In order to solve the above technical problem, the disclosure provides a fabricating method of a photo spacer in a liquid crystal display panel and a liquid crystal display panel, which can reduce the sensitivity requirement of the material for fabricating the black spacer layer, reduce the alignment difficulty of the color resists, thereby reducing the fabrication cost of the photo spacer and the liquid crystal display panel.

A fabricating method of a photo spacer in a liquid crystal display panel according to the disclosure, includes the following steps:

forming a first pad and a second pad on an array substrate, wherein the first pad is higher than the second pad, and both the first pad and the second pad are single layer pads;

forming a black spacer layer on the array substrate, and covering the first pad and the second pad by the black spacer layer; and

patterning the black spacer layer to obtain a main photo spacer, a sub photo spacer, and a black matrix having a height difference, wherein the main photo spacer is located above the first pad, and the sub photo spacer is located above the second pad, and the main photo spacer is higher than the sub photo spacer.

Preferably, forming the first pad and the second pad on the array substrate includes the following steps:

forming a color resist layer on the array substrate;

exposing and developing the color resist layer by using a conventional mask to obtain the first pad and the second pad when the color resist layer includes color resist regions with different heights, and the height difference between the color resist regions with different heights meets a setting value of height difference; and

exposing and developing the color resist layer by using one of a grayscale mask, a semi-transparent mask, and a slit mask, and a conventional mask to obtain the first pad and the second pad when the heights of different color resist regions on the color resist layer are the same or the color resist layer includes color resist regions with different heights, and the heights difference between the color resist regions with different heights do not meet the setting value of the color resist regions with different heights.

Preferably, the height difference between the main photo spacer and the sub photo spacer ranges from 0.2 μm to 0.8 μm.

Preferably, the height difference between the main photo spacer and the sub photo spacer is ΔH2, the height difference between the first pad and the second pad is ΔH1, and a ratio between ΔH2 and ΔH1 ranges from 40% to 70%.

Preferably, patterning the black spacer layer is specifically as follows:

exposing and developing the black spacer layer by using a conventional mask.

Preferably, the color resist layer is disconnected in agate line region of the array substrate.

The disclosure also provides a fabricating method of a photo spacer in a liquid crystal display panel includes the following steps:

forming a first pad and a second pad on an array substrate, the first pad being higher than the second pad, and both the first pad and the second pad being single layer pads;

forming a black spacer layer on the array substrate, and covering the first pad and the second pad by the black spacer layer; and

patterning the black spacer layer to obtain a main photo spacer, a sub photo spacer, and a black matrix having a height difference, the main photo spacer being located above the first pad, and the sub photo spacer being located above the second pad, and the main photo spacer being higher than the sub photo spacer.

The step of forming a first pad and a second pad on the array substrate includes the following steps:

forming a color resist layer on the array substrate;

exposing and developing the color resist layer by using a conventional mask to obtain the first pad and the second pad when the color resist layer includes color resist regions with different heights, and the height difference between the color resist regions with different heights meets a setting value of height difference; and

exposing and developing the color resist layer by using one of a grayscale mask, a semi-transparent mask, and a slit mask, and a conventional mask to obtain the first pad and the second pad when the heights of different color resist regions on the color resist layer are the same or the color resist layer includes color resist regions with different heights, and the heights difference between the color resist regions with different heights do not meet the setting value of the color resist regions with different heights;

and the height difference between the main photo spacer and the sub photo spacer ranges from 0.2 μm to 0.8 μm.

Preferably, the height difference between the main photo spacer and the sub photo spacer is ΔH2, the height difference between the first pad and the second pad is ΔH1, and a ratio between ΔH2 and ΔH1 ranges from 40% to 70%.

Preferably, patterning the black spacer layer is specifically as follows:

exposing and developing the black spacer layer by using a conventional mask.

Preferably, the color resist layer is disconnected in a gate line region of the array substrate.

The disclosure also provides a liquid crystal display panel including an array substrate, an upper substrate located above the array substrate, and a liquid crystal layer sandwiched between the upper substrate and the array substrate, the array substrate includes a lower substrate, and an array circuit disposed on the lower substrate;

a first pad and a second pad are disposed on the array substrate, wherein the first pad is higher than the second pad, and both the first pad and the second pad are a single layer pads;

a black spacer layer is disposed on the array substrate, the black spacer layer includes a main photo spacer, a sub photo spacer, and a black matrix with a height difference, and the main photo spacer is located above the first pad, and the sub photo spacer is located above the second pad, and the main photo spacer is higher than the sub photo spacer.

Preferably, both the first pad and the second pad are made of color resist material;

and the height difference between the main photo spacer and the sub photo spacer ranges from 0.2 μm to 0.8 μm.

Preferably, the height difference between the main photo spacer and the sub photo spacer is ΔH2, the height difference between the first pad and the second pad is ΔH1, and a ratio between ΔH2 and ΔH1 ranges from 40% to 70%.

Preferably, an upper polarizer and a lower polarizer are further included, the upper polarizer is located above the upper substrate, and the lower polarizer is located under the lower substrate.

The embodiment of the disclosure has the following advantageous effects that the height difference between the main photo spacer and the sub photo spacer of the disclosure is mainly formed based on the height difference between the first pad and the second pad, so there is no need to form a the height difference of the black spacer layer itself by 3 Tone or 2 Tone technologies, and therefore, the sensitivity requirement of the BPS material for fabricating the black spacer layer can be reduced, the cost and the difficulty of fabricating the photo spacer of the black spacer layer and the LCD panel can also be reduced. Compared with 1 Tone technology, it is not necessary to fabricate a double layer of color resist, the difficulty of aligning the color resist can be reduced and the efficiency of preparing the spacer and the liquid crystal display panel can be improved.

### BRIEF DESCRIPTION OF THE DRAWINGS

In order to illustrate technical schemes of the disclosure or the prior art more clearly, the following section briefly introduces drawings used to describe the embodiments and prior art. Obviously, the drawing in the following descriptions is just some embodiments of the disclosure. The ordinary person in the related art can acquire the other drawings according to these drawings without offering creative effort.

FIG. 1 is a flow chart of a fabricating method of photo spacers in a liquid crystal display panel according to the disclosure;

FIG. 2 is a structural schematic diagram of photo spacers provided by the disclosure;

FIG. 3 is a schematic structural view of forming a color resist layer on an array substrate provided by the disclosure;

FIG. 4 is a schematic structural view of a first pad and a second pad obtained by exposing and developing the color resist layer in FIG. 3 according to the disclosure;

FIG. 5 is a plan view of a color resist layer exposed in another embodiment of the disclosure;

FIG. 6 is a schematic view of the color resist layer provided by the disclosure being disconnected in a gate line region of the array substrate; and

FIG. 7 is a schematic structural view of a liquid crystal display panel provided by the disclosure.

### DETAILED DESCRIPTION OF PREFERRED EMBODIMENTS

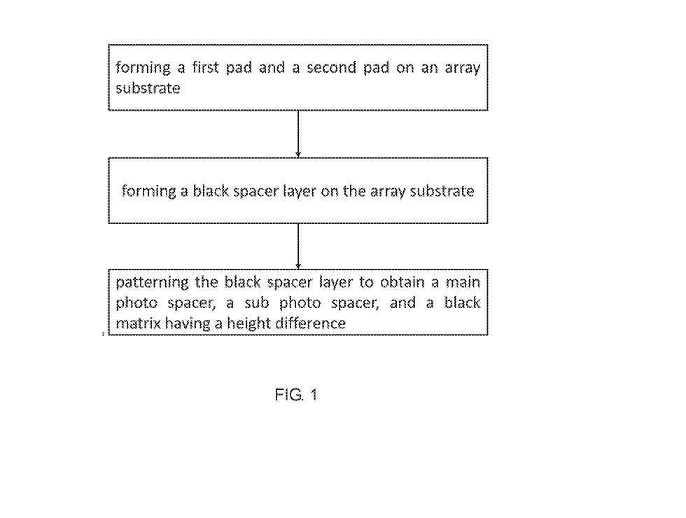

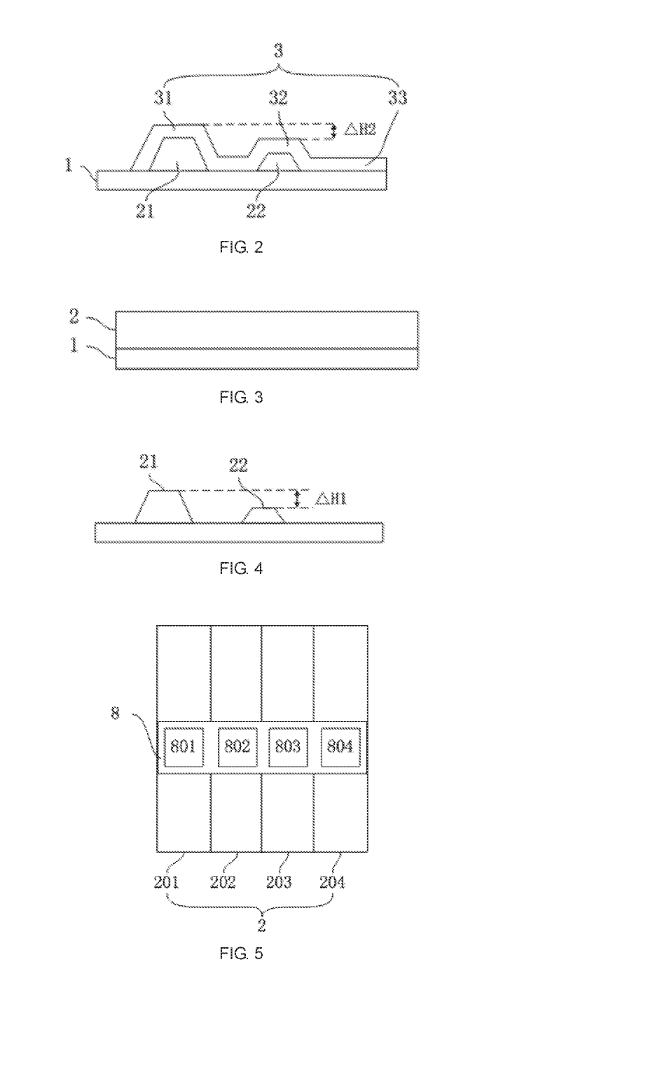

The disclosure provides a fabricating method of photo spacers in a liquid crystal display panel, as shown in FIG. 1 and FIG. 2, the fabricating method includes the following steps;

forming a first pad 21 and a second pad 22 on an array substrate, and the first pad 21 is higher than the second pad 22, and both the first pad 21 and the second pad 22 are single-layer pads;

forming a black spacer layer 3 on the array substrate 1, and covering the first pad 21 and the second pad 22 by the black spacer layer; and

patterning the black spacer layer 3 to obtain a main photo spacer 31, an sub photo spacer 32, and a black matrix 33 having a height difference, wherein the main photo spacer 31 is located above the first pad 21, and the sub photo spacer 32 is located above the second pad 22, and the main photo spacer 31 is higher than the sub photo spacer 32; The material of the black spacer layer 3 is selected from BPS material, which can be used as a black light-shielding material and can also be used as a black gap control material.

In the fabricating method of the photo spacer in the liquid crystal display panel provided in the disclosure, the height difference between the main photo spacer 31 and the sub photo spacer 32 of the disclosure is mainly formed based on the height difference between the first pad 21 and the second pad 22, since forming a the height difference of the black spacer layer itself by 3 Tone or 2 Tone technologies is not needed, so the sensitivity requirement of the BPS material for fabricating the black spacer layer 3 is not high, thereby reducing the cost and the difficulty of fabricating the photo spacer of the black spacer layer 3 and improving the efficiency of fabricating the photo spacers.

The first pad 21 and the second pad 22 provided on the array substrate 1 are both single-layer pads. In the fabrication of the first pad 21 and the second pad 22, only one layer needs to be fabricated, thereby reducing the difficulty of aligning the color resist and improving the efficiency of fabricating the photo spacers.

Further, forming the first pad 21 and the second pad 22 on the array substrate 1 includes the following steps:

as shown in FIG. 3, a color resist layer 2 is formed on the array substrate 1; and the materials of the color resist layer are all organic materials;

exposing and developing the color resist layer 2 by using a conventional mask to obtain the first pad 21 and the second pad 22 when the color resist layer 2 includes color resist regions with different heights and the height difference between the color resist regions with different heights meets a setting value of height difference, as shown in FIG. 4; it should be noted that the color resist materials of the first pad 21 and the second pad 22 may be the same or not;

exposing and developing the color resist layer 2 by using one of a grayscale mask, a semi-transparent mask, and a slit mask, and a conventional mask to obtain the first pad 21 and the second pad 22 when the heights of different color resist regions on the color resist layer are the same or the color resist layer 2 includes color resist regions with different heights, and the heights difference between the color resist regions with different heights do not meet the setting value of the color resist regions with different heights. The amount of transmitted light can be reduced by the grayscale mask, the half-tone mask, and the slit mask.

The mask generally includes a light-transmitting region and a light-blocking region. The light-transmitting region of the conventional mask is a light-transmitting region that is completely transparent (i.e., the transmittance is 100%). The light-transmitting region of the slit mask is also a light-transmitting region with completely transmission; the slit mask includes a plurality of light transmitting regions and the light transmitting regions and the light-blocking regions are spaced apart from each other. The width of the light transmitting region of the slit mask is smaller than the width of the light transmitting region of the conventional mask. Generally, the width of the light transmitting region of the slit mask is less than 5 μm, more preferably 3 μm, whereas the width of the light transmitting region of the conventional mask is more than 5 μm. Therefore, the exposure of the color resist by using the slit mask reduces the amount of light received by the color resist.

The color resist layer 2 formed on the array substrate 1 includes a red color resist, a green color resist, and a blue color resist, and the heights of the three are not necessarily the same. For example, the height of the red color resist may be the highest and the height of the blue color resist may be the lowest; if the height difference between the red color resist and the blue color resist height meets a setting value, then the color resist layer 2 can be exposed and developed by using the conventional mask directly (i.e., performing a patterning process). Specifically, a conventional mask may be used to expose and develop the red color resist, the green color resist, and the blue color resist. Then when forming a black spacer layer 3 on the patterned color resist layer 2, the main photo spacer 31, the sub photo spacer 32, and the black matrix 33 with the height difference can be formed naturally, and the main photo spacer 31 with the height step difference and the sub photo spacers 32 and the height difference between the main photo spacers 31 and the sub photo spacers 32 also meet the requirements. Since the conventional mask is easier to fabricate than the other masks such as gray mask, semi-transparent mask, and slit mask, so the color resist layer 2 is exposed and developed by using the conventional mask only, therefore the fabrication of the first pad 21 and the second pad 22 becomes easier.

When the height of the red color resist, the green color resist, and the blue color resist is the same, or the height difference between the three does not meet the setting value, one of the gray mask, the semi-transparent mask, and the slit mask and the conventional mask are used to expose and develop the color resist layer 2. For example, one or more blue color resist bars on the color resist layer 2 are exposed and developed by using a conventional mask, and the red color resist, the green color resist, and the other blue color resist are exposed and developed by using a gray mask. The amount of light received by the color resist may be reduced by using one of the grayscale mask, the semi-transparent mask, and the slit mask to exposure the color resist.

For example, in another embodiment, as shown in FIG. 5, the color resist layer 2 includes a first color resist bar 201, a second color resist bar 202, a third color resist bar 203, and a fourth color resist bar 204, and the first color resist bar 201 and the fourth color resist bar 204 are blue color resist, the second color resist bar 202 and the third color resist bar 203 are respectively red color resist and green color resist. A mask 8 is arranged above the color resist layer 2 for masking, and the mask 8 includes a conventional mask 801 and three slit masks 802, 803, and 804; the conventional mask 801 is located above the first color resist bar 201, and the three slit masks 802, 803, and 804 are respectively located above the second color resist bar 202, the third color resist bar 203, and the fourth color resist bar 204. In the exposure process, the amount of light received by the second color resist bar 202, the third color resist bar 203, and the fourth color resist bar 204 is less than the amount of light received by the first color bar 201, and after the color resist layer 2 is developed, the color resist bar 201 will be higher than the second color resist bar 202, the third color resist bar 203, and the fourth color resist bar 204, thereby forming a height difference on the color resist layer 2.

When a color filter is exposed and developed by using a slit mask, the surface of the color resist may have a rough surface. After the surface of the array substrate 1 is leveled by the BPS material, the topography and the roughness of the surface of the array substrate 1 can be optimized.

Therefore, when the exposure and the development treatment of the color resist layer 2 is performed by using a conventional mask and one of the gray mask, the semi-transparent mask and the slit mask, a three-step structure of the photo spacer can be obtained.

Further, the height difference between the main photo spacer 31 and the sub photo spacer 32 ranges from 0.2 μm to 0.8 μm.

Further, the height difference between the main photo spacer 31 and the sub photo spacer 32 is ΔH2, the height difference between the first pad 21 and the second pad 22 is ΔH1, and the ratio of Δ2 to ΔH1 ranges from 40%˜70 %, that is, ΔH2/ΔH1 is in the range of 40%˜70%.

Further, the patterned black spacer layer 3 is specifically as follows:

exposing and developing the black spacer layer 3 by using a conventional mask.

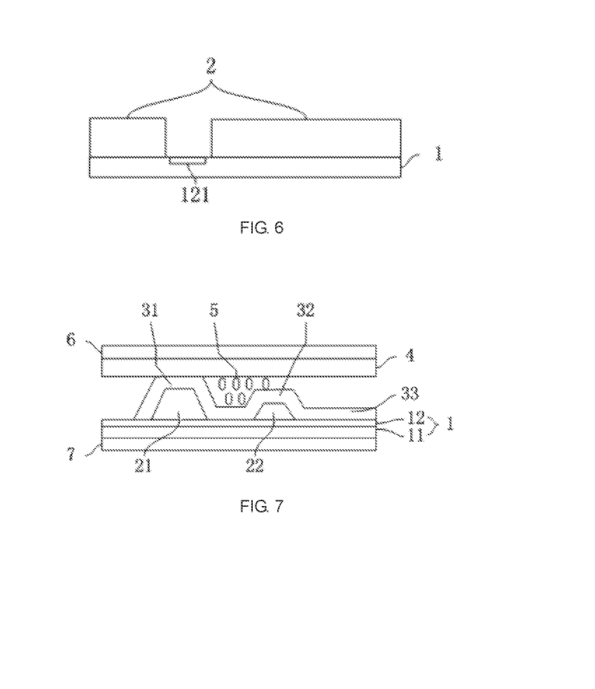

Further, as shown in FIG. 6, the color resist layer 2 is disconnected in a gate line region 121 of the array substrate 1.

The disclosure also provides a liquid crystal display panel, as shown in FIG. 7, the liquid crystal display panel includes an array substrate 1, an upper substrate 4 located above the array substrate 1, and a liquid crystal layer 5 sandwiched between the upper substrate 4 and the array substrate 1, and the array substrate 1 includes a lower substrate 11, and an array circuit 12 disposed on the lower substrate 11.

forming a first pad 21 and a second pad 22 on an array substrate 1, wherein the first pad 21 is higher than the second pad 22, and both the first pad 21 and the second pad 22 are both single layer pads.

A black spacer layer 3 is disposed on the array substrate 1, the black spacer layer 3 includes the main photo spacer 31, the sub photo spacer 32, and the black matrix 33, between which have the height difference, and the main photo spacer 31 is located above the first pad 21, and the sub photo spacer 32 is located above the second pad 22, and the main photo spacer 31 is higher than the sub photo spacer 32.

Further, both the first pad and the second pad are made of color resist material; and the height difference between the main photo spacer 31 and the sub photo spacer 32 ranges from 0.2 μm to 0.8 μm.

The height difference between the main photo spacer 31 and the sub photo spacer 32 is ΔH2, the height difference between the first pad 21 and the second pad 22 is ΔH1, and the ratio of ΔH2 to ΔH1 ranges from 40%˜70%.

Further, the liquid crystal display panel further includes an upper polarizer 6 and a lower polarizer 7, the upper polarizer 6 is located above the upper substrate 4, and the lower polarizer 7 is located below the lower substrate 11.

In summary, compared with the 3 Tone technology and the 2 Tone technology, the disclosure can reduce the cost and difficulty of fabrication of the photo spacer and the liquid crystal display panel, and compared with the 1 Tone technology, the disclosure can reduce the alignment difficulty of the color resist.

Disclosures above is a further detailed description of the disclosure in conjunction with specific alternative embodiments, and the specific embodiments of the disclosure should not be construed as being limited to this description. It will be apparent to those skilled in the art from this disclosure that various modifications or substitutions may be made without departing from the spirit of the disclosure and are intended to be within the scope of the disclosure.

What is claimed is:

1. A fabricating method of a photo spacer in a liquid crystal display panel, comprising the following steps:
forming a first pad and a second pad on an array substrate, wherein the first pad is higher than the second pad, and both the first pad and the second pad are single layer pads;
forming a black spacer layer on the array substrate, and covering the first pad and the second pad by the black spacer layer; and
patterning the black spacer layer to obtain a main photo spacer, a sub photo spacer, and a black matrix having a height difference, wherein the main photo spacer is located above the first pad, and the sub photo spacer is located above the second pad, and the main photo spacer is higher than the sub photo spacer.

2. The fabricating method of a photo spacer in a liquid crystal display panel according to claim 1, wherein the step of forming a first pad and a second pad on the array substrate comprises the following steps:
forming a color resist layer on the array substrate;
exposing and developing the color resist layer by using a conventional mask to obtain the first pad and the second pad when the color resist layer comprises color resist regions with different heights, and the height difference between the color resist regions with different heights meets a setting value of height difference;
exposing and developing the color resist layer by using one of a grayscale mask, a semi-transparent mask, and a slit mask, and a conventional mask to obtain the first pad and the second pad when the heights of different color resist regions on the color resist layer are the same or the color resist layer comprises color resist regions with different heights, and the heights difference between the color resist regions with different heights do not meet the setting value of the color resist regions with different heights.

3. The fabricating method of a spacer in a liquid crystal display panel according to claim 1, wherein the height difference between the main photo spacer and the sub photo spacer ranges from 0.2 μm to 0.8 μm.

4. The fabricating method of a spacer in a liquid crystal display panel according to claim 1, wherein the height difference between the main photo spacer and the sub photo spacer is ΔH2, the height difference between the first pad and the second pad is ΔH1, and a ratio between ΔH2 and ΔH1 ranges from 40% to 70%.

5. The fabricating method of a spacer in a liquid crystal display panel according to claim 1, wherein patterning the black spacer layer is specifically as follows:
the black spacer layer is exposed and developed using a conventional mask.

6. The fabricating method of a spacer in a liquid crystal display panel according to claim 2, wherein the color resist layer is disconnected in a gate line region of the array substrate.

7. A fabricating method of a spacer in a liquid crystal display panel, comprising the following steps:
forming a first pad and a second pad on an array substrate, wherein the first pad is higher than the second pad, and both the first pad and the second pad are single layer pads;
forming a black spacer layer on the array substrate, and covering the first pad and the second pad by the black spacer layer; and
patterning the black spacer layer to obtain a main photo spacer, a sub photo spacer, and a black matrix having a height difference, wherein the main photo spacer is located above the first pad, and the sub photo spacer is located above the second pad, and the main photo spacer is higher than the sub photo spacer;
wherein forming a first pad and a second pad on the array substrate comprises the following steps:
forming a color resist layer on the array substrate;
exposing and developing the color resist layer by using a conventional mask to obtain the first pad and the second pad when the color resist layer comprises color resist regions with different heights, and the height difference between the color resist regions with different heights meets a setting value of height difference;
exposing and developing the color resist layer by using one of a grayscale mask, a semi-transparent mask, and a slit mask, and a conventional mask to obtain the first pad and the second pad when the heights of different color resist regions on the color resist layer are the same or the color resist layer comprises color resist regions with different heights, and the heights difference between the color resist regions with different heights do not meet the setting value of the color resist regions with different heights;
wherein the height difference between the main photo spacer and the sub photo spacer ranges from 0.2 μm to 0.8 μm.

8. The fabricating method of a spacer in a liquid crystal display panel according to claim 7, wherein the height difference between the main photo spacer and the sub photo spacer is ΔH2, the height difference between the first pad and the second pad is ΔH1, and a ratio between ΔH2 and ΔH1 ranges from 40% to 70%.

9. The fabricating method of a spacer in a liquid crystal display panel according to claim 7, wherein patterning the black spacer layer is specifically as follows:
exposing and developing the black spacer layer by using a conventional mask.

10. The fabricating method of a spacer in a liquid crystal display panel according to claim 7, wherein the color resist layer is disconnected in a gate line region of the array substrate.

11. A liquid crystal display panel, comprising: an array substrate; an upper substrate located above the array substrate; and a liquid crystal layer sandwiched between the upper substrate and the array substrate, wherein the array substrate comprises a lower substrate, and an array circuit disposed on the lower substrate;
a first pad and a second pad are disposed on the array substrate, wherein the first pad is higher than the second pad, and both the first pad and the second pad are single-layer pads;
a black spacer layer is disposed on the array substrate, wherein the black spacer layer comprises a main photo spacer, a sub photo spacer, and a black matrix with height differences, wherein the main photo spacer is located above the first pad, the sub photo spacer is located above the second pad, and the main photo spacer is higher than the sub photo spacer.

12. The liquid crystal display panel according to claim 11, wherein
the first pad and the second pad are made of color resist material;
and the height difference between the main photo spacer and the sub photo spacer ranges from 0.2 μm to 0.8 μm.

13. The liquid crystal display panel according to claim 11, wherein the height difference between the main photo spacer and the sub photo spacer is ΔH2, the height difference between the first pad and the second pad is ΔH1, and a ratio between ΔH2 and ΔH1 ranges from 40% to 70%.

14. The liquid crystal display panel according to claim 11, wherein further comprises an upper polarizer and a lower polarizer, the upper polarizer is located above the upper substrate, and the lower polarizer is located under the lower substrate.
